(19) United States
(12) Patent Application Publication
(10) Pub. No.: US 2014/0230672 A1
(43) Pub. Date: Aug. 21, 2014

(54) APPARATUS FOR FLEXOGRAPHIC PRINTING OF A WEB OF PACKAGING MATERIAL

(71) Applicant: TETRA LAVAL HOLDINGS & FINANCE S.A., Pully (CH)

(72) Inventors: Ingvar Andersson, Loddekopinge (SE); Stefan Nyborg, Arlov (SE); Michael Hermansson, Helsingborg (SE); Peter Öhman, Lund (SE)

(21) Appl. No.: 14/127,500

(22) PCT Filed: Oct. 25, 2012
(86) PCT No.: PCT/EP2012/071112

§ 371 Date: Dec. 19, 2013

(30) Foreign Application Priority Data
Nov. 3, 2011 (SE) 1151034-4

(51) Int. Cl. B41F 31/02

(52) U.S. Cl. CPC B41F 31/022
USPC 101/363

(57) ABSTRACT

The disclosure relates to an apparatus for flexographic printing of a web of packaging material. The apparatus has an anilox roll which is rotary in an ink pan or chamber for picking up and transferring printing ink to an impression cylinder which is rotary adjacent the anilox roll and forms, together with a counter pressure cylinder rotary adjacent the impression cylinder, a nip through which the web is led for receiving printing ink from the impression cylinder. In order to prevent printing ink from drying and adhering to the anilox roll, the apparatus displays a spray- or shower device through which a cleaning fluid for the printing ink is applied on the circumferential surface of the anilox roll.

### TECHNICAL FIELD

The present invention relates to an apparatus for printing employing flexographic printing technology. In particular, the present invention relates to such an apparatus for printing of a web of packaging material with printing ink, the apparatus comprising an ink pan or chamber and an anilox roll partly rotary within the ink chamber for picking up and transferring printing ink from the ink chamber to a printing cylinder which is rotary in transfer contact with the anilox roll, as well as a counter pressure cylinder which is rotary adjacent the printing cylinder and which, together with the printing cylinder, forms a nip through which the web of packaging material is intended to be led for transferring printing ink from the printing cylinder to the web, the ink pan or chamber extending axially along the anilox roll and displaying an upper axial doctor blade in contact with the circumferential surface of the anilox roll for scraping off excess ink, and a lower similarly axial doctor blade in contact with the circumferential surface of the anilox roll for preventing printing ink from running out from the ink chamber, the ink chamber having a first end wall at its one axial end and a second end wall at its other axial end.

### BACKGROUND ART

In general, flexographic printing of a web of packaging material is carried into effect using a thin-running and often volatile printing ink which implies that the printing ink must be transferred from the ink pan or chamber to the packaging material web before it has had time to dry on route. For this transfer, use is therefore made of a hard roll (anilox roll) which displays on its circumferential surface engraved cells with the aid of which printing ink is taken up from the ink pan or chamber and transferred to the printing cylinder rotary in transfer contact with the anilox roll. In order to facilitate taking up of printing ink from the ink chamber, the anilox roll is rotary in direct contact with the printing ink in the ink chamber. The ink chamber is defined upwardly by an upper axial elongate doctor blade in contact with the circumferential surface of the anilox roll, and downwardly by a lower, similarly axially extending doctor blade in contact with the circumferential surface of the anilox roll. The upper doctor blade, which lightly abuts against the circumferential surface of the anilox roll, is intended to scrape off and recycle picked up excess ink before departure from the ink chamber. The lower doctor blade, which lightly abuts against the circumferential surface of the anilox roll, is intended to prevent printing ink from leaking out from the ink chamber.

The ink chamber is filled to a predetermined level with continuously circulating printing ink, via an inlet and an outlet to the ink chamber. The quality of the printing ink is continuously regulated in an external unit, in respect of viscosity and temperature and other properties so that a uniform printing result is obtained.

Both of the axial end walls of the ink chamber may, in a prior art apparatus, extend right up to sealing abutment against the circumferential surface of the anilox roll in order to ensure that as little printing ink as possible leaks out laterally from the ink chamber.

According to another prior art example, the end walls are disposed in spaced apart relationship from the surface of the anilox roll, in which event sealing against leakage of printing ink through the thus formed gaps between each respective end wall and the circumferential surface of the anilox roll is catered for by means of an observed relationship between the viscosity of the printing ink and the speed of rotation of the anilox roll during ongoing printing. According to this relationship, there is for each viscosity a speed of rotation above which the tendency of the printing ink to accompany the anilox roll is greater than the tendency of the printing ink to leak out from the ink chamber laterally through the thus formed gaps at the axial end wall. Thus, this prior art embodiment affords the advantage in relation to the previously described embodiment that it requires no frequently recurring operational stoppage for replacement of worn rubber seals. A further advantage is that it causes no wear, or very slight wear, to the anilox roll because of friction heat as described above.

One drawback inherent in this latter described embodiment is however that it not seldom occurs that residual printing ink on the circumferential surface of the anilox roll, after transfer of printing ink to the printing cylinder, dries and adheres to the anilox roll and as a result cannot be scraped off by the doctor blades, but accompanies the anilox roll into the ink pan or chamber when the anilox roll is rotated during operation. Such drying of printing ink is repeated turn after turn which the anilox roll rotates and leads to an increasing accumulation of dried printing ink which gradually grows in the radial direction and progressively lifts both the lower and the upper doctor blade, with consequentially increased losses of printing ink from the ink chamber.

A further drawback which is associated with both of the above described prior art embodiments is that the ink picking up engraved cells on the circumferential surface of the anilox roll, after transfer of the picked up printing ink to the printing cylinder are filled with air which passes beneath the lower doctor blade and accompanies the anilox roll into the ink chamber where it is released and accumulates along an axial stretch between the axial end walls of the ink chamber. According as the accumulated air volume inside the ink chamber increases, the risk also increases that air fills the whole or parts of the engraved cells on the roll surface and thereby prevents these cells from taking up printing ink.

There is thus still a need in the art for an improved apparatus for flexographic printing of a web of packaging material.

### Objects of the Invention

One object of the present invention is thus to obviate the above-described drawbacks inherent in the prior art apparatuses for flexographic printing of a web of packaging material.

A further object of the present invention is to realise an apparatus of the type described by way of introduction without suffering from the problems and drawbacks of the type described above.

Further objects and advantages of the present invention will be apparent from the following description.

### Brief Outline of the Invention

According to one aspect of the present invention, there will thus be realised an apparatus for printing of a web of packaging material with printing ink, the apparatus comprising an ink pan or chamber and an anilox roll rotary partly inside the ink chamber for taking up and transferring printing ink from the ink chamber to a rotary printing cylinder in transfer contact with the anilox roll, as well as a further counter pressure cylinder which is rotary adjacent the printing cylinder and which, together with the printing cylinder, forms a nip through which the web of packaging material is intended to be led for transferring printing ink from the printing cylinder to the web, the ink pan or chamber extending axially along the anilox roll and displaying an upper axial doctor blade in contact with the circumferential surface of the anilox roll for scraping off excess ink, and a lower, similarly axial doctor blade in contact with the circumferential surface of the anilox roll for preventing printing ink from running out from the ink chamber, the ink chamber displaying a first end wall at its one axial end and a second end wall at its other axial end. The apparatus according to the invention is characterised in that it includes at least one spray- or shower device provided with a nozzle, which has its nozzle directed to peripheral circumferential edge regions of the circumferential surface of the anilox roll for supplying a cleaning fluid to these regions for removing and thereby preventing printing ink from drying and adhering within such edge regions.

The spray- or shower device preferably has its nozzle directed to the peripheral edge regions of the anilox roll.

With the aid of this spray- or shower device, it is thus possible constantly during ongoing printing to keep the residual printing ink within these peripheral regions of the circumferential surface of the anilox roll in a liquid state and by such means avoid this printing ink from “fouling” on the circumferential surface of the anilox roll, even in that case when the pertinent printing ink is dissolved in a volatile solvent which readily becomes fugitive at a relatively low temperature. To this end, the spray- or shower device provided with the nozzle is connectable to a suitable source of cleaning fluid for the printing ink through a hose or a conduit.

In one particularly preferred embodiment of the apparatus according to the present invention, the first and/or second axial end wall of the ink chamber has a through-going outlet aperture for removing air from the ink chamber.

In one practical embodiment, each respective axial end wall is configurated as a unit module of two mutually spaced apart configurated end wall elements, the through-going outlet aperture being provided in the wall element located most proximal the centre of the ink chamber. By such means, printing ink which, where applicable, leaks out laterally from the ink chamber is collected and taken care of via the interjacent outlet and is thereby prevented from causing splashing and soiling.

Such a unit module of end wall elements is preferably manufactured from a rubber or plastic material.

According to yet a further embodiment of the present invention, the axial end walls of the ink chamber extend towards and terminate a short distance from the circumferential surface of the anilox roll rotary partly inside the ink chamber, for the formation of a gap between the anilox roll and each respective end wall. The thus formed gap has a gap width of approx. 0.5-1.5 mm when the apparatus is employed for printing a web of packaging material which is driven at a web speed of approx. 400-600 m/min.

Further, the edge of each respective end wall facing towards the anilox roll may display a geometric configuration which is adapted to the opposing convex circumferential surface of the anilox roll, the thus adapted geometric configuration preferably being such that the gap between the anilox roll and each respective end wall displays a constant width throughout the entire length of the gap.

In one embodiment of the apparatus according to the present invention, both axial end walls of the ink chamber are disposed in contact with the circumferential surface of the anilox roll.

According to still a further embodiment, both axial end walls of the ink chamber are disposed a short distance from the circumferential surface of the anilox roll, sealing of the thus formed gap between the ink chamber and the circumferential surface of the anilox roll being in this case catered for by means of the previously described relationship between the viscosity of the printing ink and the relevant speed of rotation of the anilox roll.

In yet a further embodiment of the apparatus according to the present invention, in particular in that case when the axial end walls of the ink chamber extend up to and are in abutment with the circumferential surface of the anilox roll, at least one of the two end walls is provided with an air bleeder hole in line with or substantially flush with the axial stretch of air accumulated inside the ink chamber which has accompanied the anilox roll and is released inside the ink chamber.

In that the chamber side wall is disposed a distance from the surface of the anilox roll, no sealing rubber projections are required on the end walls in frictional contact with the circumferential surface of the anilox roll, at the same time as these end walls are not worn or exposed to abrasion by the rotating anilox roll either. In other words, wear of both the end walls and the anilox roll can be avoided almost completely. Moreover, nor is any frictional heat generated which would raise the temperature of the printing ink and thereby occasion unevenness and poor quality in the printing result, or even coagulation of printing ink at the ends of the ink chamber, with similar consequential deterioration in printing result.

Practical examples of cleaning fluid to be used in connection with the apparatus according to the present invention can be either gaseous or liquid fluid. Preferred such liquid cleaning fluid are chosen from the group consisting of water, solvent for the actual print ink in use, and the actual print ink in use. The most preferred liquid cleaning fluid for use in the apparatus according to the invention is the actual print ink in use, since it already has the appropriate composition, temperature and viscosity and will therefore have only a negligible impact on the qualities of the print ink in use. As a consequence, the actual print ink in use is the far superior choice of cleaning fluid in connection with an apparatus according to the invention in which the axial end walls of the ink chamber extend towards and terminate a short distance from the circumferential surface of the anilox roll rotary partly inside the ink chamber, for the formation of a gap between the anilox roll and each respective end wall, as mentioned above. Still another advantage of using the actual print ink as said cleaning fluid is that it does not require any extra complicated equipment for application. To this end it will suffice to supplement the apparatus with only one extra tube or hose in fluid communication with the print ink present in the ink chamber of the apparatus and the at least one spray- or shower device.

Additional advantages and preferred embodiments of the apparatus according to the present invention have further been given the characterising features as set forth in the appended subclaims.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a perspective view of an apparatus according to the present invention for flexographic printing;

FIG. 2 is a schematic side elevation of an anilox roll in combination with an ink pan or chamber;

FIG. 3 is a schematic sectional view of the ink chamber according to FIG. 2;

FIG. 4 schematically illustrates one example of an end wall module for the axial ends of the ink chamber; and

FIG. 5 schematically illustrates the apparatus according to the present invention on printing of a web of packaging material with printing ink.

### DETAILED DESCRIPTION OF THE INVENTION

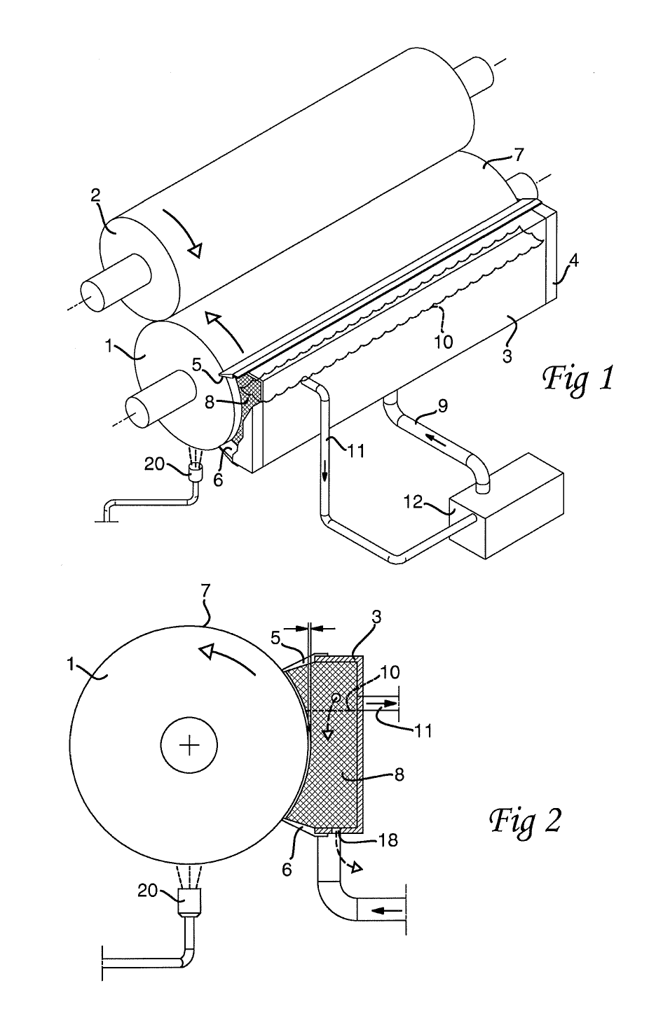

Referring to the Drawings, FIG. 1 thus shows one example of an apparatus according to the present invention. The apparatus has an anilox roll 1, a printing cylinder in the form of an impression plate cylinder 2 (hereinafter designated impression cylinder) and an ink pan or chamber 3, the ink chamber being disposed axially along the one side of the anilox roll 1. The ink chamber 3 is defined by a first chamber wall 4, an upper and a lower doctor blade 5, 6, part of the circumferential surface 7 of the anilox roll 1, as well as by an end wall 8 at each respective axial end of the ink chamber 3. The first chamber wall 4 may be designed as a curved, C-shaped or U-shaped wall or as a planar wall, depending upon the length of the doctor blades 5, 6 employed and depending upon how the doctor blades are fixed at the first chamber wall. Suitably, the wall is designed as an integrated unit in which the doctor blades are secured.

In order to maintain uniform quality and uniform properties of the printing ink, the ink is circulated continuously through the ink chamber 3 by the intermediary of an inlet 9 and fills up the ink chamber to a predetermined level 10, before being led out of the chamber by the intermediary of an outlet 11. The viscosity, temperature and homogeneity of the printing ink are regulated in an external unit 12 (only illustrated schematically), including int. al. agitators and temperature control. It is important that printing ink be transferred to the impression cylinder 2 from the anilox roll 1 in a uniform quantity and with uniform quality, so that no differences occur in printing result between different regions of the printed web. In such instance, the continuous circulation of printing ink plays a decisive part, in that the ink in then continuously monitored and regulated in respect of important properties, regardless of whether the printing process is in operation or whether the printing unit for some reason is inoperative. It is also important that the anilox roll 1 be constantly kept wet and filled with printing ink and be uniformly coated with ink also in stationary downtime, so that the ink does not dry and occasion problems in later printing processes. Suitably, the printing ink is led into the ink chamber 3 by the intermediary of an inlet 9 in or close to the bottom of the ink chamber and out of the chamber by the intermediary of an outlet 11 on a level just above the maximum level 10 to which printing ink is intended to be filled in the chamber.

The end wall 8 is disposed such that the edge which faces towards the surface of the anilox roll 1 adheres to the configuration of the anilox roll but at a distance from the circumferential surface 7 of the anilox roll. Between the circumferential surface 7 of the anilox roll 1 and the edge of the end wall 8 there is thus a gap which may have a width of from approx. 0.5 mm to approx. 2 mm, preferably from approx. 0.5 mm to approx. 1.5 mm, most preferably from approx. 0.6 to approx. 1.0 mm.

When the rolls and cylinders of the apparatus, including the anilox roll 1, are rotated at a certain minimum speed, the printing ink in the ink chamber forms a liquid film along this gap so that liquid no longer leaks out from the ink chamber 3 through the gap.

A most preferred gap width for a water-based printing ink which is often used for printing a web of packaging material for liquid foods and which has a viscosity of approx. 20 s is from approx. 0.6 to approx. 0.9 mm.

As shown in the figure, the apparatus according to the present invention has one or more (in the figure only one is shown) spray- or shower devices 20 provided with a nozzle, which via a hose or conduit 21 may be in flow communication with a suitable source of cleaning fluid for the relevant printing ink.

As mentioned above, operative cleaning fluid can be either gaseous or liquid type fluid. Preferred examples of such liquid type fluid can be chosen from the group consisting of water, solvent, and the actual print ink in use. For water-based print inks, the cleaning fluid is preferably water, and for solvent-based print inks the cleaning fluid is preferably the solvent for the actual print ink. The most preferred cleaning fluid or liquid is however the actual print ink in use as explained above.

Said spray- or shower device 20 is, in the illustrated embodiment, positioned adjacent the anilox roll 1 and has its nozzle directed towards the axial end of the anilox roll 1 in order to spray the cleaning fluid towards the axial end regions of the circumferential surface 7 of the anilox roll 1 and thereby prevent any possible residual printing ink at these regions of the circumferential surface 7 from drying and “fouling” on the anilox roll 1, as was mentioned previously. While being preferred to dispose the spray device 20 at a position outside the ink chamber 3, as shown, it may when necessary also be placed at other suitable positions in association with the anilox roll 1, on condition however that it is always placed after the transfer by the anilox roll 1 of printing ink to the impression cylinder 2.

According to the present invention, the spray- or shower device 20 may be disposed to continuously apply cleaning fluid during ongoing printing to the ends of the anilox roll 1, but it is often sufficient that the device applies the cleaning fluid intermittently at frequencies which in all essentials are determined by the consistency and viscosity of the printing ink employed. With printing inks which contain a large proportion of pigment and, as a result, have a high viscosity, it is advantageous to apply the cleaning fluid with rapid pulsations, while it is often sufficient to use slow pulsations in connection with printing inks of slight viscosity (a low proportion of pigment in relation to the quantity of solvent).

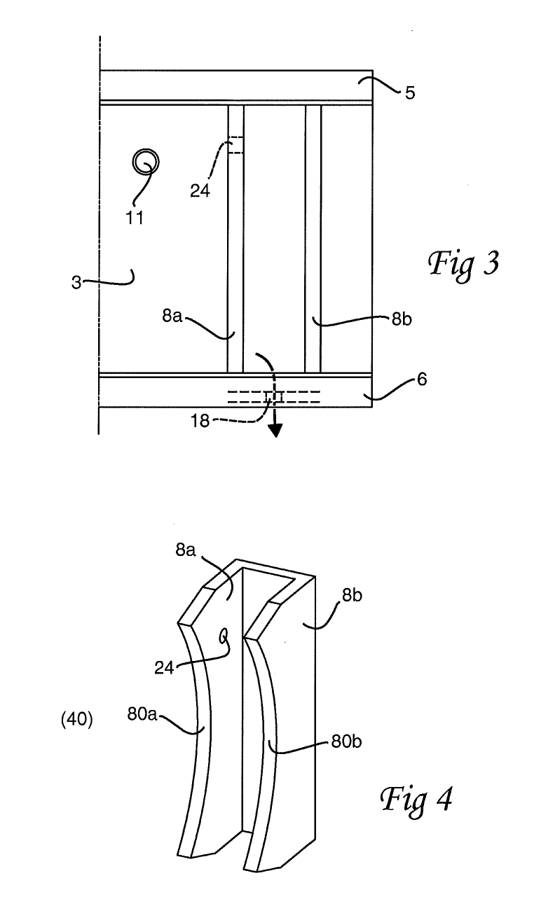

The illustrated apparatus in FIG. 1 preferably also has an aperture provided in the one axial end wall 8 of the ink chamber 3 (schematically illustrated in FIGS. 3 and 4) for ventilation of the ink chamber 3 during operation. The ventilation aperture through which air which accompanies the rotating anilox roll 1 into the ink chamber 3 is released and accumulated in an axial stretch throughout the entire length of the ink chamber on a more or less predictable level within the chamber as has been previously explained. With a suitable geometric configuration and positioning of the ventilation aperture, this may thus be effectively utilized for frequently removing the thus accumulated air from the air chamber and thereby prevent or considerably counteract consequential tendencies to frothing inside the ink chamber and tendencies to deterioration in print quality related to such frothing.

FIG. 2 is a schematic end elevation of an apparatus with an anilox roll 1 and associated ink chamber 3 according to another embodiment of the present invention. On the one hand, FIG. 2 shows how the side chamber wall 8 may be designed so that its wall is disposed at one and the same distance from the surfaces of the doctor blades 5 and 6 as from the circumferential surface 7 of the anilox roll 1. In the same manner as the gap to the circumferential surface 7 of the anilox roll 1 is sealed by the printing ink when the anilox roll 1 is rotated at a speed of rotation above a certain minimum speed of rotation, as was explained earlier, the gap between the anilox roll 1 and the doctor blades 5, 6 is sealed in the same manner and for the same reasons.

In FIG. 2, the ink chamber 3 has two end walls 8, an inner 8a and an outer end wall 8b (shown in FIG. 3). FIG. 2 shows a cross section of the ink chamber 3 along a line taken between the inner 8a and the outer end wall 8b. The visible end wall is thus the inner end wall 8a.

Outside the inner end wall 8a, there is located an outlet 18 for excess ink which has been scraped off from the circumferential surface 7 of the anilox roll 1 after absorption of printing ink in the ink chamber 3 which is led off from the ink chamber by the intermediary of the outlet 18. In connection with start-up of the apparatus, and in connection with operation of the apparatus being arrested for repair or maintenance or the like, the speed of rotation of the anilox roll is at least temporarily slower than the speed of rotation which is required to counteract the tendency of the picked up printing ink to leak out laterally from the ink chamber 3, for which reason leakage of printing ink cannot be avoided during such occasions. By such an arrangement with an extra end wall (i.e. two end walls 8a and 8b, instead of merely one end wall), the ends of the anilox roll 1 may nevertheless be kept clean and the entire printing unit can be protected from ink spatter.

FIG. 3 is a cross sectional view of the one axial end of an ink chamber according to the same embodiment as in FIG. 2, seen from the position of the anilox roll in front of the ink chamber, but with the anilox roll removed.

In this example, the ink chamber is defined by an elongate first chamber wall 4, an upper doctor blade 5 and a lower doctor blade 6, and thus has two end walls, an inner end wall 8a and an outer end wall 8b, at each respective axial end of the ink chamber.

Outside the inner end wall 8a, there is disposed an outlet for excess ink 18, through which printing ink is led off from the ink chamber by the intermediary of the outlet 18. In connection with start-up of the apparatus and in connection with operation of the apparatus being arrested for repair or maintenance and the like, the speed of rotation of the anilox roll is at least temporarily slower than the speed of rotation which is required to counteract the tendency of the picked up printing ink to leak out laterally from the ink chamber 3, for which reason leakage of printing ink cannot be avoided during such occasions. By such an arrangement with an extra end wall (i.e. two end walls 8a and 8b, instead of merely one end wall), the ends of the anilox roll 1 may nevertheless be kept clean and the entire printing unit be protected from ink spatter. One example of positioning of the outlet 18 for the circulating printing ink is also shown.

As was mentioned earlier, the one axial end wall 8a of the ink chamber (the inner end wall) has an aperture 24 provided in the end wall 8a for ventilation of the ink chamber during operation. The ventilation aperture 24 through which air which accompanies the rotating anilox roll 1 into the ink chamber is released and accumulated in an axial stretch throughout the entire length of the ink chamber on a more or less predeterminable level inside the ink chamber, as was previously explained. With a suitable geometric configuration and positioning of the ventilation aperture 24, this may thus effectively be utilized for frequently removing the thus accumulated air from the ink chamber and thereby prevent or considerably counteract consequential tendencies to frothing inside the ink chamber and tendencies to deterioration in print quality related to such frothing.

FIG. 4 shows one embodiment of an axial end wall which, in the illustrated embodiment, has two end walls 8a and 8b which are mutually spaced apart and are designed in one continuous piece. The illustrated integral end wall is designed as a readily replaceable module of a suitable plastic or rubber material. The end wall module has an inner 8a and an outer end wall 8b with front edges whose configuration is adapted to follow the cylindrical circumferential surface of the anilox roll. In the lower region of the module, which is intended to be turned to face towards the bottom of the ink chamber, there is disposed an outlet 14 which, during operation, is disposed to lead off printing ink which may have leaked out from the ink chamber through the gap between the inner end wall 8a and the circumferential surface of the anilox roll. Alternatively, each respective front edge (80a, 80b) of the two side walls may be provided with a thinner projection of plastic or rubber material which is disposed a distance from the surface of the anilox roll (not shown in the figure). Such an end wall module is thus suitably manufactured from a plastic or rubber material, and includes an inner end wall and an outer end wall, the inner end wall having a thickness of between 2 and 5 mm and with a spacing of from 20 to 50, preferably from 20 to 40 mm between the two end walls.

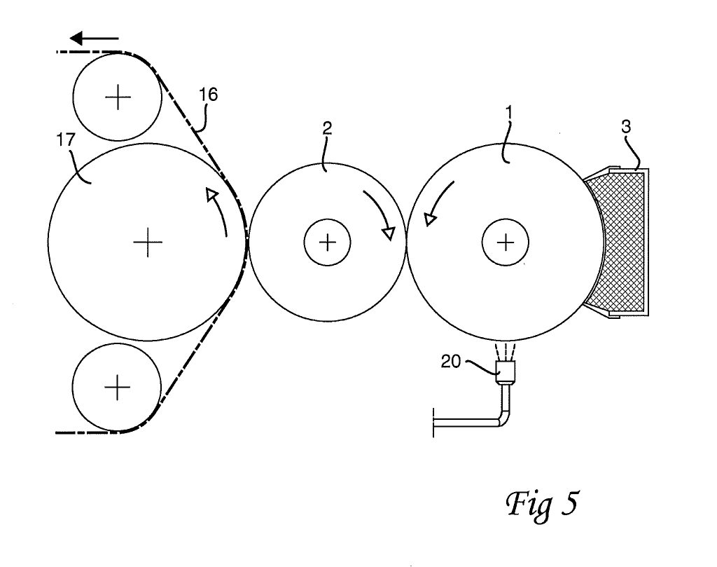

FIG. 5 schematically illustrates a printing process employing the apparatus according to the present invention. In FIG. 5, the same reference numerals as earlier have been employed for the same or equivalent parts. The anilox roll 1 is rotated in the direction of rotation of the arrow, partly within the ink chamber 3 positioned axially along the roll 1 for taking up printing ink in the cells engraved on the circumferential surface of the roll 1. Picked up excess ink is scraped off from the roll 1 by an upper doctor blade (obscured in the figure) abutting against the circumferential surface, on exit from the ink chamber 3. The printing ink thus remaining in the engraved cells accompanies the rotating anilox roll 1 and is transferred to an impression cylinder 2 rotating in transfer contact with the anilox roll 1. The printing ink thus transferred to the impression cylinder 2 accompanies the rotating impression cylinder 2 for transfer to a web 26 of packaging material which is led through the nip between the impression cylinder 2 and a counter pressure cylinder 17 rotating adjacent the impression cylinder 2. After drying/setting of the transferred printing ink on the surface of the web, the printed web is rolled up for further processing, such as lamination and mechanical processing in a per se known manner.

In order to maintain good print quality and reduce process-related quality disruptions, but also to minimise unnecessary waste and spillage of expensive printing ink because of uncontrolled leakage of printing ink, the apparatus according to the invention has a spray- or shower device 20 disposed adjacent the anilox roll in order, during ongoing operation, to continuously or intermittently spray cleaning fluid for the printing ink on particularly sensitive regions of the circumferential surface of the anilox roll 1. Such a region is the peripheral edge regions of the anilox roll 1 where printing ink in certain cases (in particular printing ink with a high proportion of pigment in relation to solvent) shows a tendency to dry on the anilox roll, as has been previously explained. Such undesirable drying of the printing ink is effectively counteracted with the aid of the applied cleaning fluid which ensures that residual printing ink within these sensitive regions on the surface of the anilox roll is constantly kept in soluble form.

1. An apparatus for flexographic printing of a web of packaging material with printing ink, the apparatus comprising:
an ink pan or chamber and an anilox roll rotary partly inside the ink chamber for picking up and transferring printing ink from the ink chamber to an impression cylinder which is rotary in transfer contact with the anilox roll, as well an additional counter pressure cylinder which is rotary adjacent the impression cylinder and which, together with the impression cylinder, forms a nip through which the web of packaging material is intended to be led for transferring printing ink from the impression cylinder to the web, the ink chamber being elongate and extending axially along the anilox roll and having an upper axial doctor blade in contact with the circumferential surface of the anilox roll, for scraping off excess ink, and a lower similarly axial doctor blade in contact with the circumferential surface of the anilox roll for scraping off residual printing ink after the transfer to the impression cylinder, and said ink chamber having a first end wall its one axial end and a second end wall at its other axial end, in at least one spray- or shower device provided with a nozzle, which has its nozzle directed towards peripheral edge regions of the circumferential surface of the anilox roll for supplying cleaning fluid, for the printing ink to these regions.

2. The apparatus as claimed in claim 1, wherein said cleaning fluid is chosen from the group consisting of water, solvent for the actual print ink in use, and the actual print ink in use, preferably the actual print ink in use.

3. The apparatus as claimed in claim 1, wherein the spray- or shower device is disposed with its nozzle directed towards the edge regions of the anilox roll in immediate association with the lower axial doctor blade on the re-entry of the rotating anilox roll into the ink chamber.

4. The apparatus as claimed in claim 1, wherein the spray- or shower device provided with a nozzle is communicable with a source of the gaseous- or liquid solvent through a hose or conduit.

5. The apparatus as claimed in claim 1, wherein the first and/or second axial end wall of the ink chamber has an outlet aperture for removal of air from the ink chamber.

6. The apparatus as claimed in claim 1, wherein each respective axial end wall is configurated as a unit module of two mutually spaced apart configurated end wall elements, the outlet aperture being provided in the wall element located most proximal the centre of the ink chamber.

7. The apparatus as claimed in claim 6, wherein said unit module of wall elements is manufactured from metal, rubber or plastic.

8. The apparatus as claimed in claim 1, wherein the axial end walls of the ink chamber extend towards, but terminate a short distance from the circumferential surface of the anilox roll rotary partly inside the ink chamber, for the formation of a gap between the anilox roll and each respective end wall.

9. The apparatus as claimed in claim 8, wherein the gap between the anilox roll and each respective end wall has a width of between 0.5 and 2 mm.

10. The apparatus as claimed in claim 5, wherein the edge of each respective end wall facing towards the anilox roll has a geometric configuration which is adapted to the opposing convex circumferential surface of the anilox roll.

11. The apparatus as claimed in claim 10, wherein the gap between the anilox roll and each respective end wall has a constant width throughout the entire length of the gap.
